(19) United States
(12) Patent Application Publication
(10) Pub. No.: US 2012/0225199 A1
(43) Pub. Date: Sep. 6, 2012

(54) CURRENT COLLECTOR COATING FOR LI-ION BATTERY CELLS USING AQUEOUS BINDER

(75) Inventors: Milburn Ebenezer Jacob Muthu, Breinigsville, PA (US); Monira Mamari, Allentown, PA (US); Chester Crane, Bangor, PA (US)

(73) Assignee: INTERNATIONAL BATTERY, INC., Allentown, PA (US)

(21) Appl. No.: 13/473,076

(22) Filed: May 16, 2012

Related U.S. Application Data
(63) Continuation-in-part of application No. 12/701,001, filed on Feb. 5, 2010, now Pat. No. 8,076,026.
Application No. 12/701,001 is a continuation-in-part of application No. 13/073,082, filed on Mar. 28, 2011, now Pat. No. 8,092,557.
Application No. 13/073,082 is a division of application No. 12/941,100, filed on Nov. 8, 2010, now Pat. No. 7,931,985.

(51) Int. Cl. H01B 1/12; B05D 5/12

(52) U.S. Cl. 427/126.4; 427/58; 427/126.3; 427/126.6; 252/500

(57) ABSTRACT

A coating for a current collector for a rechargeable electrochemical cell comprising a water-soluble polymeric material that provides suitable binding and coating characteristics without the need for a thickening agent or any external reagent to control the viscosity of the electrode active mix. Multiple water-based polymeric materials are disclosed. Also disclosed is an electrode active mix that is devoid of any thickening agent or any external reagent to control the viscosity of the electrode active mix.

### CROSS REFERENCE TO RELATED APPLICATION(S)

The present application is a continuation-in-part of U.S. patent application Ser. No. 12/701,001, filed Feb. 5, 2010, now issued as U.S. Pat. No. 8,076,026, and U.S. patent application Ser. No. 13/073,082, filed Mar. 28, 2011, which is a divisional of U.S. patent application Ser. No. 12/941,100, filed Nov. 8, 2010, now issued as U.S. Pat. No. 7,931,985, the disclosures of which are all incorporated herein by reference as if fully set forth.

### FIELD OF INVENTION

The present invention relates to binders used in current collector coatings used in li-ion battery cells.

### BACKGROUND

Rechargeable battery cells, such as Li-ion cells, use polymer binders to bind together the active material, which is a particulate, and adhere the active material to the current collector in the fabrication of electrodes. The binder is generally comprised of one or more polymers. Most li-ion batteries of the prior art use non-aqueous binders that are very slightly soluble or practically insoluble in water, in other words, at least 1000 parts of the solvent (water) are required to dissolve one part of the solute (the binder).

Examples of such non-aqueous binders include polyvinyledene fluoride (PVDF), ethylene-propylene and a diene (EPDM). These binders are typically dissolved in an organic solvent such as N-methyl pyrrolidone (NMP). The organic solvent additionally serves as a dispersion medium for the active material.

Efforts have been made to use binders other than PVDF because PVDF is highly unstable and tends to break down at high temperatures. In addition, efforts have been made to use water-soluable (aqueous) binders due to the relatively high cost and toxicity of organic solvents. Carboxy methyl cellulose (CMC) has been used, but requires the use of a thickening agent to control the viscosity of the binder and does not exhibit preferred adhesion and flexibility characteristics. Polytetrafluoroethylene (PTFE) and styrene butadiene rubber (SBR) binders have also been used, but exhibit less than ideal adhesion, flexibility, and cycle life. Further, SBR binders exhibit high expandability and undesirable agglomeration characteristics resulting in poor dispersion, poor performance, and high electrode resistance. Due to the poor adhesion and flexibility of these binders, they tend to delaminate from the current collectors, thereby increasing the internal resistance and negatively affecting the performance of the cell.

Accordingly, there is a need for an electrode coating for li-ion battery cells using a water-based binder that exhibits good adhesion and flexibility in the absence of thickening agents (and preferably wetting agents), low resistance and good chemical and electrochemical stability.

### SUMMARY OF THE INVENTION

In one respect, the present invention comprises a method of making a coating for a current collector for an electrochemical cell, the method comprising: coating a current collector with an electrode active mix, the electrode active mix being comprised of an electrode active material, a conductive additive material, a water-soluble polymeric binder, and water, the electrode active mix having a viscosity in the range of 2,000 to 100,000 centipoise (2 Pa·s to 100 Pa·s), the electrode active mix being devoid of a thickening agent or any external reagent to control the viscosity of the electrode active mix; and allowing the electrode active mix to dry onto the current collector to form a dried coating comprising at least 70 percent by weight electrode active material.

In another respect, the present invention comprises a method of making a coating for a current collector for an electrochemical cell, the method comprising: coating a current collector with an electrode active mix, the electrode active mix being comprised of an electrode active material, a conductive additive material, a water-soluble polymeric binder, and water, the electrode active mix having a viscosity in the range of 2,000 to 100,000 centipoise (2 Pa·s to 100 Pa·s), and a zeta-potential greater than ±30 millivolts, the electrode active mix being devoid of a thickening agent or any external reagent to control the viscosity of the electrode active mix; and allowing the electrode active mix to dry onto the current collector to form a dried coating comprising at least 70 percent by weight electrode active material, the dried coating having sufficient characteristics for adhesion according to ASTM standard test D3359-09e2, entitled Standard Test Methods for Measuring Adhesion by Tape Test, and sufficient characteristics for flexibility according to the Mandrel Test.

In yet another respect, the present invention comprises an electrode active mix for coating onto a current collector for an electrochemical cell, the electrode active mix comprising: an electrode active material; a conductive additive material; a water-soluble polymeric binder; and water, the electrode active mix having a viscosity in the range of 2,000 to 100,000 centipoise (2 Pa·s to 100 Pa·s), the electrode active mix being devoid of a thickening agent or any external reagent to control the viscosity of the electrode active mix.

### BRIEF DESCRIPTION OF THE DRAWINGS

The foregoing summary, as well as the following detailed description of the invention, will be better understood when read in conjunction with the appended drawings. For the purpose of illustrating the invention, there is shown in the drawing certain embodiments of the present invention. It should be understood, however, that the invention is not limited to the precise arrangements shown. In the drawings:

FIG. 1 is a schematic view of a battery formed in a jellyroll configuration according to an exemplary embodiment of the present invention;

FIG. 2 is a schematic view of the battery of FIG. 1 with the electrolyte;

FIG. 3 is a schematic representation of a positive electrode, a separator and a negative electrode-bi-cell configuration of the exemplary embodiment illustrated in FIG. 1;

FIG. 4 is a partial cross-sectional representation of a prismatic electrochemical cell according to an exemplary embodiment of the present invention;

FIG. 5 is a charge/discharge curve for a LiFePO₄ cathode and a graphite anode cell according to an exemplary embodiment of the present invention;

FIG. 6 is a cycle life curve for the LiFePO₄ cathode and graphite anode cell whose charge/discharge curve is illustrated in FIG. 5;

FIG. 7 is a charge/discharge curve for a LiNi_{1/3}Co_{1/3}Mn_{1/3}O₂ cathode and a graphite anode cell according to another exemplary embodiment of the present invention;

FIG. 8 is a cycle life curve for the LiNi_{1/3}Co_{1/3}Mn_{1/3}O₂ cathode and graphite anode cell whose charge/discharge curve is illustrated in FIG. 7; and

FIG. 9 is a charge/discharge curve for a LiFePO₄ electrode and a Lithium metal electrode, showing current versus test time.

### DETAILED DESCRIPTION OF THE PREFERRED EMBODIMENTS

In describing the embodiments of the invention illustrated in the drawings, specific terminology will be used for the sake of clarity. However, the invention is not intended to be limited to the specific terms so selected, it being understood that each specific term includes all technical equivalents operating in similar manner to accomplish similar purpose. It is understood that the drawings are not drawn exactly to scale.

The following describes particular embodiments of the present invention. It should be understood, however, that the invention is not limited to the embodiments detailed herein. Generally, the following disclosure refers to lithium ion batteries and a water soluble binder for use in lithium ion batteries.

For purposes of this description and the appended claims, the term “water soluble” means a binder that is at least slightly soluble in water, in other words, no more than 1000 parts of the solvent (water) are needed to dissolve every one part of the solute (binder).

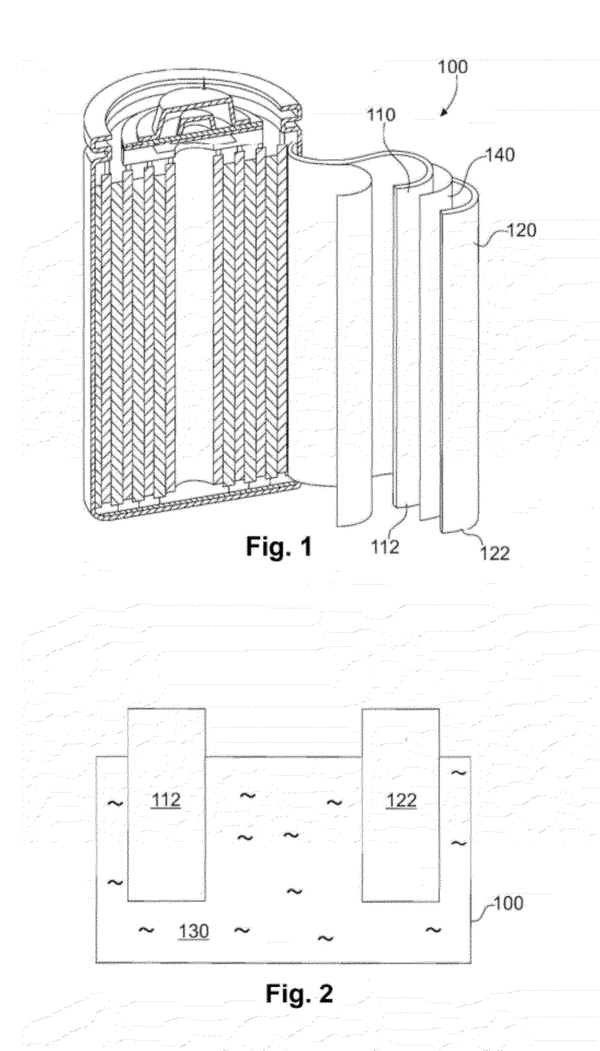

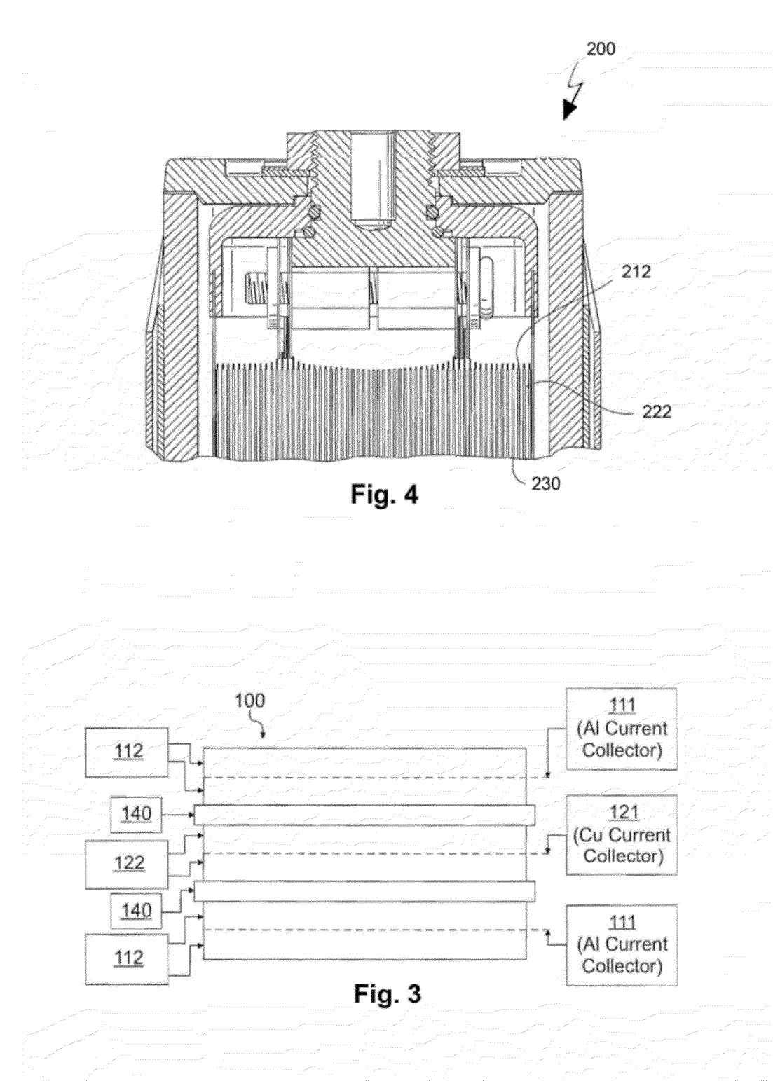

Referring to FIGS. 1 through 3, an exemplary embodiment of a rechargeable li-ion battery cell 100 is shown. The cell 100 includes multiple, alternating layers of positive electrodes 112 and negative electrodes 122, each separated by a separator 140. Each positive electrode consists of an aluminum current collector 111 (represented schematically in FIG. 3 as a dashed line) coated with a positive electrode active mix 110. Each negative electrode 122 consists of a copper current collector 121 (represented schematically in FIG. 3 as a dashed line) coated with a negative electrode active mix 120. (The positive electrode active mix 110 and negative electrode active mix 120 may both be referred to, in the alternative, as an electrode “slurry”). It should be noted that the relative thicknesses shown in FIG. 3 are not to scale.

In the cell 100, the electrodes 112, 122 and the separators 140 are rolled into a roughly cylindrical shape, which is often referred to in the art as a “jellyroll” cell configuration. The “jellyroll” of positive electrodes 112, negative electrodes 122, and separators 140 are soaked in an electrolyte 130 (shown schematically in FIG. 2). The electrolyte 130 facilitates the transfer of ions between positive electrode 112 and negative electrode 122.

FIG. 4 illustrates another cell 200, which represents a prismatic configuration. In this configuration, the positive and negative electrodes 212, 222 and separators (not shown) are arranged in a planar stack, which is soaked in the electrolyte 230.

To form the cell 100, the positive electrode active mix 110 is coated on a current collector 111, which may be aluminum, carbon-coated aluminum, steel, nickel, or combinations thereof, thereby forming a positive electrode 112. The negative electrode active mix 120 is coated on a current collector 121, which may be copper or aluminum, thereby forming negative electrode 122. Optionally, the electrodes 112, 122 may then be dried in a vacuum oven or by other known drying means. In some embodiments, the respective electrode slurry may be coated onto a first side of a continuous piece of current collector (known as continuous web coating), which is then run through elongated horizontally-oriented ovens in order to dry the electrode active mix on the first side of the electrode material. The continuous piece of electrode material is then coated on its second side with the electrode active mix, and then re-routed through the ovens in order to dry the electrode active mix on the second side of the electrode material. In the alternative, the electrode material could simultaneously be coated on both sides with the electrode active mix and dried using horizontally-oriented ovens. Positive electrode 112 and negative electrode 122 are then cut to size, compressed or calendared to achieve a specific thickness and porosity, and stacked as shown in FIG. 3. The stack is then dried in a vacuum oven until the moisture is below 2000 ppm, and most preferably below 200 ppm. The electrode stack may be inserted into a polyethylene or polypropylene cell housing (not shown), and filled with electrolyte 130, thereby forming the cell 100. The cell 100 is then charged and discharged to complete the forming process.

An exemplary electrolyte 130 may be comprised of lithium salts such as LiBF₄, LiPF₆, LiBOB, LiTFSI or LiFSI or mixtures thereof in cyclic and linear carbonates or other known solvents.

In an exemplary embodiment, positive electrode active mix 110 includes a positive electrode active material selected from the group consisting of LiCoO₂, LiNi_{1/3}Co_{1/3}Mn_{1/3}O₂, LiNi_{0.8}Co_{0.15}Al_{0.05}O₂, Li₁₊ₓNi_{1/3}Co_{1/3}Mn_{1/3}O₂, LiMn₂O₄, LiFePO₄ coated with at least one of graphite, carbon, and Li₂Mn₂O₄, LiNiCoAlO₂, LiNi_{y}CoₓM_{z}O, where M=Mn, Al, Sn, In, Ga or Ti and 0.15<x<0.5, 0.5<y<0.8 and 0<z<0.15, Li[Li_{(1-2y)/3}Ni_{y}Mn_{(2-y)/3}]O₂, Li[Li_{(1-y)/3}Co_{y}Mn_{(2-2y)/3}]O₂ and Li[Ni_{y}Co_{1-2y}Mn_{y}]O₂, where x=(2−y)/3 and 0<y<0.5, LiNiCoO₂.MnO₂, lithium rich compounds Li_{1+y}(Ni_{1/3}Co_{1/3}Mn_{1/3})_{1-y}O₂, where y=x/(2+x) and x=0-0.33, and xLi₂MnO₃(1−x)Li(NiCoMn)O₂ and Li_{(1+y)}(Ni_{0.5}Co_{0.2}Mn_{0.3})_{1-y}O₂, where y=x/(2+x) and x=0-0.33, and LiMPO₄, where M is one or more of the first row transition-metal cations selected from the group consisting of V, Cr, Mn, Fe, Co, Ni, and combinations thereof. Preferably, the positive electrode active material comprises at least 70 percent (by weight) of the positive electrode active mix 110 when the positive electrode active mix 110 has been coated onto the current collector 111 and dried. More preferably, the positive electrode active material comprises at least 80-95 percent (by weight) of the positive electrode active mix 110 when the positive electrode active mix 110 has been coated onto the current collector 111 and dried.

The positive electrode active mix 110 preferably also includes at least one conductive additive material selected from the group consisting of carbon black, acetylene black, carbon fibers, coke, high surface area carbon, graphite, and combinations thereof. In an exemplary embodiment, the conductive additive material is about 1-10 percent (by weight) of the positive electrode active mix 110. If a carbon-coated electrode is used, the conductive additive material may be about 0-10 percent (by weight) of the positive electrode active mix 110.

The positive electrode active mix 110 also includes water and a polymeric binder that is used to bind the positive electrode active material and the conductive additive material together to form the positive electrode active mix 110 (a.k.a., slurry). As noted above, the slurry is coated on an aluminum current collector or a carbon coated aluminum current collector to form the positive electrode 112. In exemplary embodiments, the pH of the slurry may, for example, be between about 5 and about 12. If the positive active material contains LiFePO₄, the pH of the slurry is preferably between about 6 and about 10. If the positive active material contains LiNi_{1/3}Co_{1/3}Mn_{1/3}O₂, the pH of the slurry is preferably between about 10 and about 12. In an exemplary embodiment, the polymeric binder comprises about 1-10 percent (by weight) of the positive electrode active mix 110, after drying.

The polymeric binder is preferably no less than slightly soluble in water and, more preferably, no less than freely soluble in water. The polymeric binder is also preferably capable of providing a viscosity in the electrode slurry ranging between 2,000 and 100,000 cP (2 Pa·s to 100 Pa·s), and more preferably between 4,000 and 20,000 cP (4 Pa·s to 20 Pa·s) in the absence of a thickening agent. For purposes of this application, a thickening agent is intended to have its ordinary meaning in the art, i.e., a substance that increases the viscosity of a mixture without substantially modifying other properties of the mixture. The viscosity of the slurry was measured using a Brookfield viscometer (Model RVTDV-II) using spindle 6 at room temperature and a spindle speed of 6.

It is also preferable that the binder provide a desired level of dispersion of the active material and, if applicable, the conductive additive material, without the use of a wetting agent. In addition, the binder should exhibit good chemical and electrochemical stability, as will be appreciated by one having ordinary skill in the art. It is desirable that the slurry, containing the binder, exhibit these characteristics in order to both properly bind the slurry to the current collectors—in order to improve adhesion of the slurry from the current collectors—and to maximize the electrochemical connection in the slurry between molecules of the electrode active material. In some embodiments, the slurry preferably has a zeta-potential (ζ-potential) in the range greater than ±30 mV (i.e., greater than −30 mV to +30 mV).

It is also desirable that the selected binder polymer have good flexibility and adhesion characteristics once the positive electrode active mix 110, including said binder, has been coated and dried onto the electrode layers. Applicants have devised tests for determining whether the selected binder displays requisite flexibility and adhesion characteristics once dried onto the electrode layers. In order to measure flexibility characteristics, Applicants have adopted the Mandrel Test, which is known in the coating industry. In one embodiment of this test, which was employed by Applicants, the coated electrode is wrapped around a cylinder having a diameter of 20 mm. If the coating does not visibly crack or delaminate when this test is performed, the coating is considered to “pass” the Mandrel Test. If the coating does visibly crack or delaminate when this test is performed, the coating is considered to “fail” the Mandrel Test. Whether a pass or a fail result is achieved on the Mandrel Test is a direct function of the characteristics of the polymer binder that has been included in the electrode active material. In this way, suitable binder polymer(s) having the desired flexibility characteristics can be identified.

In order to measure adhesion characteristics, Applicants have employed ASTM standard test D3359-09e2, entitled Standard Test Methods for Measuring Adhesion by Tape Test, in order to measure whether the selected binder displays the requisite adhesion characteristics once dried onto the electrode layers. As employed by Applicants, this test involves placing a piece of 3M invisible tape, measuring 6 inches (152.4 mm) by 0.75 inches (19.05 mm), on the surface of a dried electrode (which has been dried in an oven overnight at 100 degrees Celsius) for 10 seconds, then removing the piece of tape at a medium rate from the surface of the electrode. If more than 90 percent of the coating material remains on the electrode layer after the adhesive tape has been removed, this indicates a “pass” result for the adhesion test. Otherwise, a “fail” result for the adhesion test is indicated. In this way, suitable binder polymer(s) having the desired adhesion characteristics can be identified. The percentage of coating material that remains on the electrode layer may be analyzed by analyzing a photographic image of the electrode layer or adhesive tape and calculating the quantity of coating material that is present based on a percentage of the total surface area of the electrode layer or adhesive tape.

Applicants have discovered several water-soluble binders that satisfy the flexibility and adhesion criteria set forth in the previous paragraphs. Applicants have also discovered that the ability to use these binders without the need for a thickening agent is both a function of the unique properties of the binders themselves and the process by which the positive electrode active mix 110 and negative electrode active mix 120 are made. Applicants have also discovered that some water soluble binders are less sensitive to process variations.

Suitable water soluble binders include poly vinyl alcohols (PVA), polyvinyl pyrrolidone, polyethylene oxides (PEO), polyethylene glycols, polyacrylamide (PAAm), poly-N-isopropylearylamide, poly-N,N-dimethylacrylamide, polyethyleneimine, polyoxyethylene, polyvinylsulfonic acid, poly(2-methoxyethoxyethoxyethylene), styrene butadiene rubber (SBR), butadiene-acrylonitrile, rubber (NBR), hydrogenated NBR (HNBR), epichlorhydrin rubber (CHR) and acrylate rubber (ACM), polyactic acid (PLA), polyacrylic acid (PAA), polysuccinic acid, poly maleic acid and anhydride, poly furoic (pyromucic acid), poly fumaric acid, poly sorbic acid, poly linoleic acid, poly linolenic acid, poly glutamic acid, poly methacrylic acid, poly licanic acid, poly glycolic acid, poly aspartic acid, poly amic acid, poly formic acid, poly acetic acid, poly propoionic acid, poly butyric acid, poly sebacic acid, acrylic acid-type water-soluble polymers, maleic anhydride-type water-soluble polymers, poly(N-vinyl amides), polyacrylamides, for example N-methylacrylamide, N-ethyl acrylamide, N,N-dimethyl acrylamide, and N,N-diethyl acrylamide, poly(hydroxy-ethyl methacrylate), polyesters, poly(ethyl oxazolines), poly(oxymethylene), poly(vinyl methyl ether), poly(styrene sulfonic acid), poly(ethylene sulfonic acid), poly(vinyl phosphoric) acid, poly(maleic acid), starch, cellulose, protein, polysacchride, dextrans, tannin, lignin, a polyethylene-polypropylene copolymer, or mixtures or co-polymers thereof. The polymer binder may also comprise physically- and/or chemically-modified versions of any of the polymer binders listed above. Preferred water-soluble binders may include CMC, PVA, PAA, physically- and/or chemically-modified SBR, PEO, or co-polymers of PAN and polyacrylonitrile, PEO and PAAm, PVA and PAAm, or PEO and PAN, or co-polymers or mixtures thereof (e.g., a physical blend (mixture) and/or co-polymers of the polymers mentioned above). One having ordinary skill in the art will appreciate that the above list of suitable polymers and co-polymers is exemplary only, and is not intended to limit the scope of the present invention.

Applicants have identified two additional co-polymers that appear to be particularly well-suited to serve as the binder in the positive electrode active mix 110 or negative electrode active mix 120. These co-polymers are particularly suitable because of their good chemical and electrochemical stability, adhesion to the current collector, flexibility, and glass transition temperature, as well as the presence of functional groups. The first co-polymer is poly(acrylonitrile-co-acrylamide). One example of a suitable poly(acrylonitrile-co-acrylamide) polymer binder has the chemical formula:

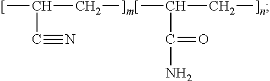

where the mole ratio of acrylonitrile units to acrylamide units (m:n) is preferably between about 3:1 and 1:3. In some embodiments, the ratio of m to n is preferably approximately 2:1. In other embodiments, the ration of m to n is preferably approximately 1:1.8. The second co-polymer is a co-polymer of polystyrenebutadiene rubber and poly(acrylonitrile-co-acrylamide). One example of a suitable co-polymer of polystyrenebutadiene rubber and poly(acrylonitrile-co-acrylamide) has the chemical formula:

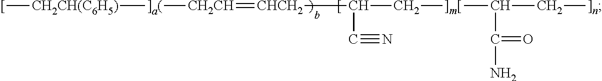

where a, b, m, and n are each greater than zero and are percentages that add up to 100 percent (i.e., positive decimal values that add up to 1). In one exemplary embodiment, a=b=m=n=0.25. In another exemplary embodiment, a>b and m>n. In another exemplary embodiment, a=0.3, b=0.2, m=0.333, and n=0.167.

In one embodiment, in order to form an electrode layer coating for a cell, the polymeric binder, the conductive additive material (or the components of a conductive gel formed therefrom), the electrode active material, and water are first mixed together in a container to form an electrode slurry. The electrode slurry is then delivered from the container and coated onto a first side of a foil layer. The foil layer is then placed in an oven in order to bake the electrode slurry onto the first side of the foil layer. The electrode slurry is then coated onto the second side of the foil layer. The foil layer is then placed in an oven in order to bake the electrode slurry onto the second side of the foil layer. A cell may then be assembled from the multiple coated foil layers as taught herein. In these embodiments, the drying steps may occur in elongated horizontally-oriented ovens, as noted above.

In some embodiments, negative electrode active mix 120 comprises a negative electrode active material and materials selected from the group consisting of graphite, hard carbon, silicon, tin, lithium titanate, and any combination thereof. In an exemplary embodiment, the negative electrode active material is at least 70 percent (by weight) of the negative electrode active mix 120. More preferably, the negative electrode active material is about 80-95 percent (by weight) of the negative electrode active mix 120.

Negative electrode active mix 120 further includes a conductive additive material selected from the group consisting of carbon black, acetylene black, carbon fibers, coke, high surface area carbon, graphite and combinations thereof. In an exemplary embodiment, the conductive additive material is about 0-10 percent (by weight) of the negative electrode active mix 120.

In some embodiments, the negative electrode active mix 120 further comprises the same water soluble binder that, as described above, has been chosen for the positive electrode active mix 110. In an exemplary embodiment, the water soluble binder is about 1-10 percent (by weight) of the negative electrode active mix 120.

### EXAMPLES

The following examples are given purely as an illustration and should not be interpreted as constituting any kind of limitation to the invention.

### Example #1

Positive electrode active mix 110 was prepared first by dissolving PEO polymer binder in water. The amount of binder relative to the amount of water was in the range of approximately 15 to 20 percent. A positive active powder (carbon- and/or graphite-coated LiFePO₄, manufactured by Phostech Lithium, Canada) with an appropriate amount of conductive additive material, such as for example Super P®, manufactured by Timcal Graphite & Carbon, Switzerland, was mixed with the binder in water solution for about 2 hours. The pH of the electrode slurry for the LiFePO₄ positive mix was between about 7 and about 9. The homogeneously mixed electrode slurry was then coated on the aluminum current collector or a carbon coated aluminum current collector 111 to form the positive electrode 112. Positive electrode 112 was then cut into an appropriate size and dried in a vacuum oven until the moisture was below about 1000 ppm, and most preferably below about 200 ppm.

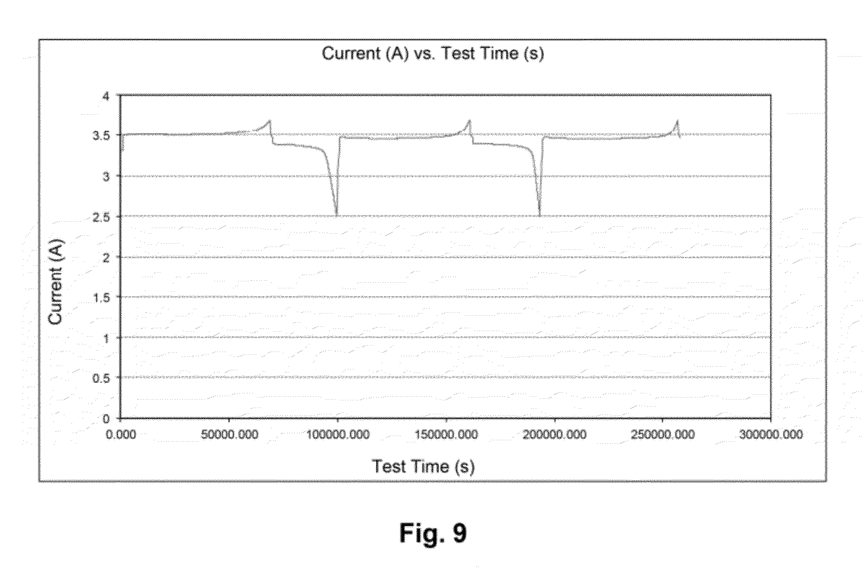

Electrochemical characterization was performed by building lithium half cells. Lithium half cells were built using lithium metal and LFP electrodes as described above. Electrolyte and separators were used for building lithium half cells according to the arrangement shown in FIGS. 1-3 and described above. The cells were galvanostatically charged at C/20 to 3.7V and allowed to rest for 20 minutes. The cells were then discharged at a C/10 rate down to 2.5V and allowed to rest again for 20 minutes before another charging. The lithium half cells were cycled between 3.7 and 2.5V for five cycles. FIG. 9 illustrates a charge/discharge curve for a LiFePO₄ electrode and a Lithium metal electrode, showing current versus test time.

### Example #2

Positive electrode active mix 110 was prepared first by dissolving a poly(acrylonitrile-co-acrylamide) copolymer binder in water. A positive active powder (LiNi_{1/3}Co_{1/3}Mn_{1/3}O₂ manufactured by 3M corporation, USA), with an appropriate amount of conductive additive material (e.g., Super P®), was mixed with the binder in water solution for about 2 hours. The pH of the electrode slurry for LiNi_{1/3}Co_{1/3}Mn_{1/3}O₂ positive electrode active mix was between about 10 and about 12. The homogeneously mixed electrode slurry was then coated on the aluminum current collector or a carbon coated aluminum current collector 111 to form positive electrode 112. Positive electrode 112 was cut into an appropriate size and dried in a vacuum oven until the moisture was below about 1000 ppm, and most preferably below about 200 ppm.

Negative electrode active mix 120 was prepared first by dissolving a poly(acrylonitrile-co-acrylamide) copolymer binder in water. The amount of binder relative to the amount of water was in the range of approximately 15 to 20 percent. A negative active powder (graphite) with an appropriate amount of conductive additive material (e.g., Super P®) was mixed with the binder in water solution and mixed for about 2 hours. The pH of the electrode slurry was between about 10 and 12. The homogeneously mixed slurry was then coated on to copper current collector 121 to form negative electrode 122. Negative electrode 122 was cut into an appropriate size and dried in a vacuum oven until the moisture was below about 1000 ppm, and most preferably below about 200 ppm.

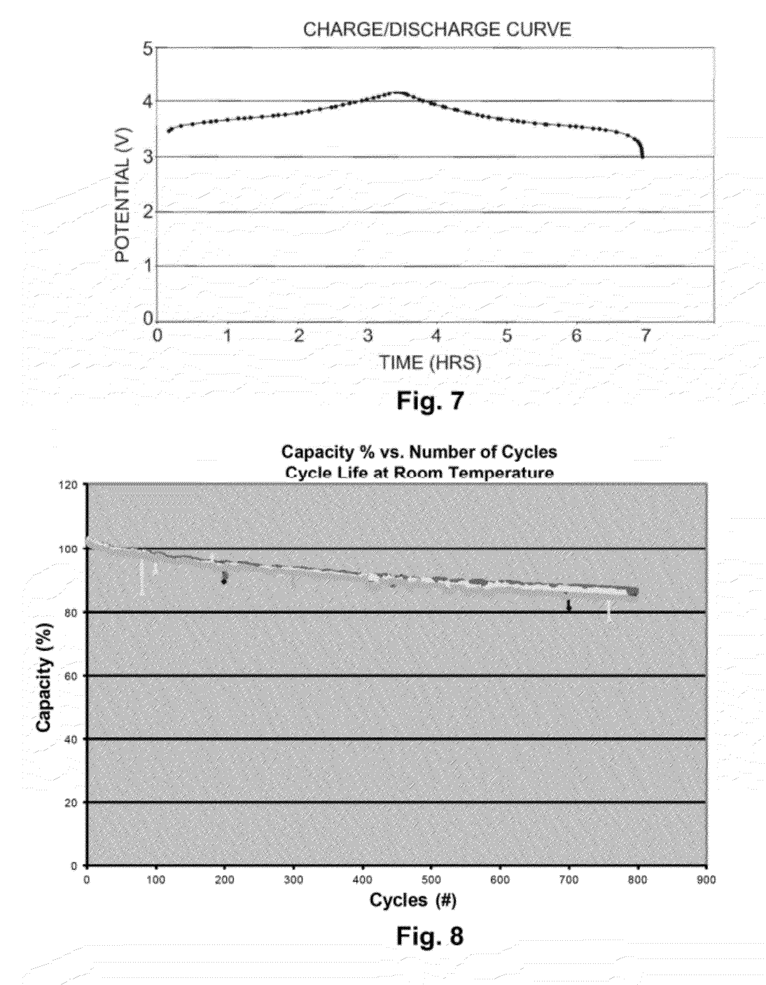

The cells were built as described in FIGS. 1-3. The cells were then filled with electrolyte 130. The Li-ion cells were in discharged state and had a potential of a few millivolts. FIG. 7 illustrates a charge/discharge curve for a LiNi_{1/3}Co_{1/3}Mn_{1/3}O₂ cathode and a graphite anode. FIG. 8 illustrate a cycle life curve for the LiNi_{1/3}Co_{1/3}Mn_{1/3}O₂ cathode and graphite anode.

### Example #3

Positive electrode active mix 110 was prepared first by dissolving a poly(acrylonitrile-co-acrylamide) binder in water. A positive active powder (carbon- and/or graphite-coated LiFePO₄, manufactured by Phostech Lithium, Canada, with an appropriate amount of conductive additive material such as for example Super P®, manufactured by Timcal Graphite & Carbon, Switzerland, was mixed with the binder in water solution for about 2 hours. The pH of the slurry for LiFePO₄ positive mix was between about 7 and about 9. The homogeneously mixed electrode slurry was then coated on the aluminum current collector or a carbon coated aluminum current collector 111 to form positive electrode 112. Positive electrode 112 was cut into an appropriate size and dried in a vacuum oven until the moisture was below about 1000 ppm and most preferably below about 200 ppm.

Negative electrode active mix 120 was prepared first by dissolving a poly(acrylonitrile-co-acrylamide) binder in water. The amount of binder relative to the amount of water was in the range of approximately 15 to 20 percent. A negative active powder (graphite) with an appropriate amount of conductive additive material (e.g., Super P®) was mixed with the binder in water solution and mixed for about 2 hours. The pH of the slurry was between about 7 and about 9. The homogeneously mixed electrode slurry was then coated on to copper current collector 121 to form negative electrode 122. Negative electrode 122 was cut into an appropriate size and dried in a vacuum oven until the moisture was below about 1000 ppm, and most preferably below about 200 ppm.

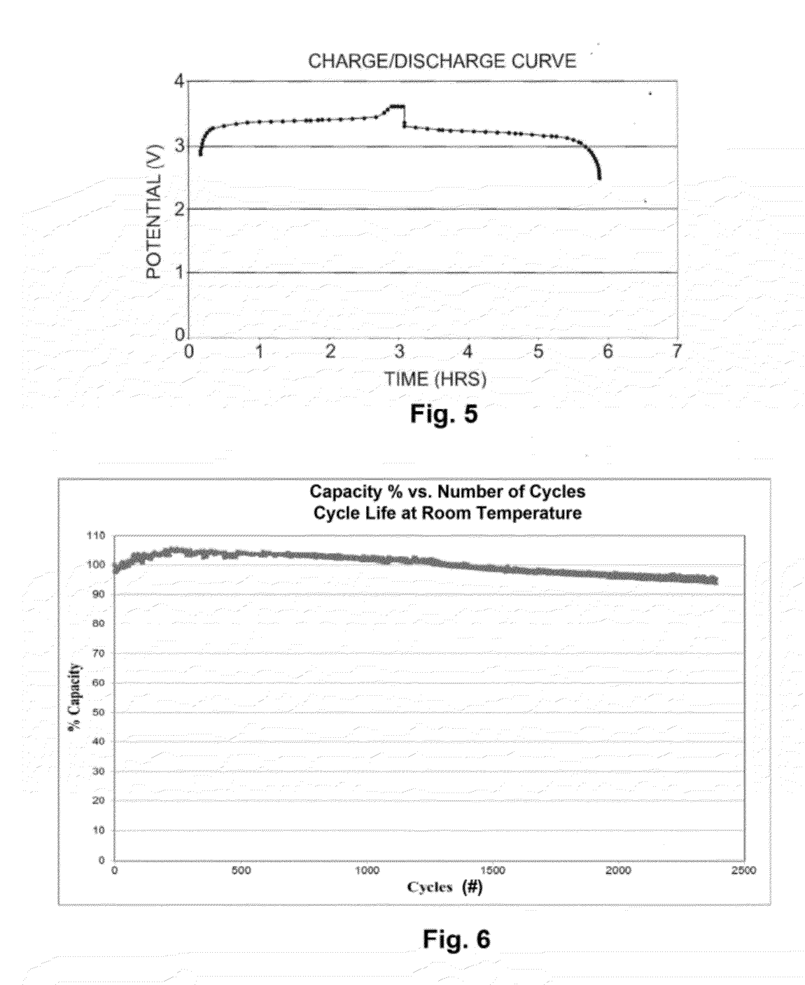

The cells were built as described in FIGS. 1-3. The cells were then filled with electrolyte 130. The Li-ion cells were in discharged state and had a potential of a few millivolts. FIG. 5 illustrates a charge/discharge curve for a LiFePO₄ cathode and a graphite anode. FIG. 6 illustrates a cycle life curve for the LiFePO₄ cathode and graphite anode.

While the principles of the invention have been described above in connection with preferred embodiments, it is to be clearly understood that this description is made only by way of example and not as a limitation of the scope of the invention.

1. A method of making a coating for a current collector for an electrochemical cell, the method comprising:
coating a current collector with an electrode active mix comprising an electrode active material, a conductive additive material, a water-soluble polymeric binder, and water, the electrode active mix having a viscosity in the range of 2,000 to 100,000 centipoise (2 Pa·s to 100 Pa·s) and being devoid of a thickening agent; and
allowing the electrode active mix to dry onto the current collector to form a dried coating comprising at least 70 percent by weight electrode active material.

2. The method of claim 1, the allowing step further comprising allowing the electrode active mix to dry onto the current collector to form the dried coating, wherein the dried coating comprises at least 80 percent by weight electrode active material.

3. The method of claim 1, the coating step further comprising coating the current collector with the electrode active mix, wherein the electrode active mix has a zeta-potential greater than ±30 millivolts.

4. The method of claim 1, the allowing step further comprising allowing the electrode active mix to dry onto the current collector to form the dried coating, wherein the dried coating has sufficient characteristics for adhesion according to ASTM standard test D3359-09e2, entitled Standard Test Methods for Measuring Adhesion by Tape Test, and sufficient characteristics for flexibility according to the Mandrel Test.

5. The method of claim 1, the coating step further comprising coating the current collector with the electrode active mix, wherein the electrode active mix has a viscosity in the range of 4,000 to 20,000 centipoise (4 Pa·s to 20 Pa·s).

6. The method of claim 1, the coating step further comprising coating the current collector with the electrode active mix, wherein the electrode active material comprises a positive active material selected from the group consisting of LiCoO₂, LiNiO₂, LiNi_{1/3}Co_{1/3}Mn_{1/3}O₂, LiNi_{0.8}Co_{0.15}Al_{0.05}O₂, Li₁₊ₓNi_{1/3}Cov_{1/3}Mn_{1/3}O₂, LiMn₂O₄, LiFePO₄ coated with at least one of graphite, carbon, and Li₂Mn₂O₄, LiNiCoAlO₂, LiNi_{y}CoₓM_{z}O, where M=Mn, Al, Sn, In, Ga or Ti and 0.15<x<0.5, 0.5<y<0.8 and 0<z<0.15, Li[Li_{(1-2y)/3}Ni_{y}Mn_{(2-y)/3}]O₂, Li[Li_{(1-y)/3}Co_{y}Mn_{(2-2y)/3}]O₂ and Li[Ni_{y}Co_{1-2y}Mn_{y}]O₂, where x=(2−y)/3 and 0<y<0.5, LiNiCoO₂.MnO₂, lithium rich compounds Li_{1+y}(Ni_{1/3}Co_{1/3}Mn_{1/3})_{1-y}O₂, where y=x/(2+x) and x=0-0.33, and xLi₂MnO₃(1−x)Li(NiCoMn)O₂ and Li(1+y)(Ni_{0.5}Co_{0.2}Mn_{0.3})_{1-y}O₂, where y=x/(2+x) and x=0-0.33, and LiMPO₄, where M is one or more of the first row transition-metal cations selected from the group consisting of V, Cr, Mn, Fe, Co, Ni, and combinations thereof.

7. The method of claim 1, the coating step further comprising coating the current collector with the electrode active mix, wherein the water-soluble polymeric binder is selected from the group consisting of poly vinyl alcohols, polyvinyl pyrrolidone, polyethylene oxides, polyethylene glycols, polyacrylamide, poly-N-isopropylearylamide, poly-N,N-dimethylacrylamide, polyethyleneimine, polyoxyethylene, polyvinylsulfonic acid, poly(2-methoxyethoxyethoxyethylene), styrene butadiene rubber, butadiene-acrylonitrile, rubber, hydrogenated NBR, epichlorhydrin rubber and acrylate rubber, polyactic acid, polyacrylic acid, polysuccinic acid, poly maleic acid and anhydride, poly furoic (pyromucic acid), poly fumaric acid, poly sorbic acid, poly linoleic acid, poly linolenic acid, poly glutamic acid, poly methacrylic acid, poly licanic acid, poly glycolic acid, poly aspartic acid, poly amic acid, poly formic acid, poly acetic acid, poly propoionic acid, poly butyric acid, poly sebacic acid, acrylic acid-type water-soluble polymers, maleic anhydride-type water-soluble polymers, poly(N-vinyl amides), polyacrylamides, for example N-methylacrylamide, N-ethyl acrylamide, N,N-dimethyl acrylamide, and N,N-diethyl acrylamide, poly(hydroxy-ethyl methacrylate), polyesters, poly(ethyl oxazolines), poly(oxymethylene), poly(vinyl methyl ether), poly(styrene sulfonic acid), poly(ethylene sulfonic acid), poly(vinyl phosphoric) acid, poly(maleic acid), starch, cellulose, protein, polysacchride, dextrans, tannin, lignin, copolymer, carboxy methyl cellulose, poly(acrylonitrile-co-acrylamide), physically- and/or chemically modified styrene butadiene rubber, polyethylene oxides, and polyacrylonitrile, and copolymers of polyethylene oxides and polyacrylonitrile, polyethylene and polypropylene, polyethylene oxides and polyacrylamide, poly vinyl alcohols and polyacrylamide, polystyrenebutadiene rubber and poly(acrylonitrile-co-acrylamide), and poly(acrylonitrile-co-acrylamide), and physically- and/or chemically-modified versions of any of the polymers or co-polymers listed above or mixtures or co-polymers of any of the polymers or co-polymers listed above.

8. The method of claim 1, the coating step further comprising coating the current collector with the electrode active mix, wherein the water-soluble polymeric binder comprises poly(acrylonitrile-co-acrylamide) having the following chemical formula: 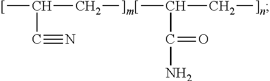
wherein a ratio of m to n is between 3:1 and 1:3.

9. The method of claim 8, the coating step further comprising coating the current collector with the electrode active mix, wherein the ratio of m to n is approximately 2:1.

10. The method of claim 8, the coating step further comprising coating the current collector with the electrode active mix, wherein the ratio of m to n is approximately 1:1.8.

11. The method of claim 1, the coating step further comprising coating the current collector with the electrode active mix, wherein the water-soluble polymeric binder comprises a copolymer of polystyrenebutadiene rubber and poly(acrylonitrile-co-acrylamide) having the following chemical formula: 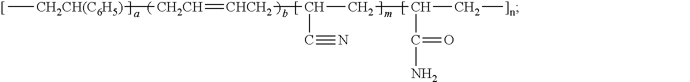
wherein a, b, m, and n comprise positive decimal values having a sum equal to 1.

12. The method of claim 11, the coating step further comprising coating the current collector with the electrode active mix, wherein a=b=m=n=0.25.

13. The method of claim 11, the coating step further comprising coating the current collector with the electrode active mix, wherein a=0.3, b=0.2, m=0.333, and n=0.167.

14. A method of making a coating for a current collector for an electrochemical cell, the method comprising:
coating a current collector with an electrode active mix, the electrode active mix being comprised of an electrode active material, a conductive additive material, a water-soluble polymeric binder, and water, the electrode active mix having a viscosity in the range of 2,000 to 100,000 centipoise (2 Pa·s to 100 Pa·s), and a zeta-potential greater than ±30 millivolts, the electrode active mix being devoid of a thickening agent or any external reagent to control the viscosity of the electrode active mix; and
allowing the electrode active mix to dry onto the current collector to form a dried coating comprising at least 70 percent by weight electrode active material, the dried coating having sufficient characteristics for adhesion according to ASTM standard test D3359-09e2, entitled Standard Test Methods for Measuring Adhesion by Tape Test, and sufficient characteristics for flexibility according to the Mandrel Test.

15. The method of claim 14, the allowing step further comprising allowing the electrode active mix to dry onto the current collector to form the dried coating, wherein the dried coating comprises at least 80 percent by weight electrode active material.

16. The method of claim 14, the coating step further comprising coating the current collector with the electrode active mix, wherein the electrode active mix has a viscosity in the range of 4,000 to 20,000 centipoise (4 Pa·s to 20 Pa·s)

17. The method of claim 14, the coating step further comprising coating the current collector with the electrode active mix, wherein the water-soluble polymeric binder is selected from the group consisting of poly vinyl alcohols, polyvinyl pyrrolidone, polyethylene oxides, polyethylene glycols, polyacrylamide, poly-N-isopropylearylamide, poly-N,N-dimethylacrylamide, polyethyleneimine, polyoxyethylene, polyvinylsulfonic acid, poly(2-methoxyethoxyethoxyethylene), styrene butadiene rubber, butadiene-acrylonitrile, rubber, hydrogenated NBR, epichlorhydrin rubber and acrylate rubber, polyactic acid, polyacrylic acid, polysuccinic acid, poly maleic acid and anhydride, poly furoic (pyromucic acid), poly fumaric acid, poly sorbic acid, poly linoleic acid, poly linolenic acid, poly glutamic acid, poly methacrylic acid, poly licanic acid, poly glycolic acid, poly aspartic acid, poly amic acid, poly formic acid, poly acetic acid, poly propoionic acid, poly butyric acid, poly sebacic acid, acrylic acid-type water-soluble polymers, maleic anhydride-type water-soluble polymers, poly(N-vinyl amides), polyacrylamides, for example N-methylacrylamide, N-ethyl acrylamide, N,N-dimethyl acrylamide, and N,N-diethyl acrylamide, poly(hydroxy-ethyl methacrylate), polyesters, poly(ethyl oxazolines), poly(oxymethylene), poly(vinyl methyl ether), poly(styrene sulfonic acid), poly(ethylene sulfonic acid), poly(vinyl phosphoric) acid, poly(maleic acid), starch, cellulose, protein, polysacchride, dextrans, tannin, lignin, copolymer, carboxy methyl cellulose, poly(acrylonitrile-co-acrylamide), physically- and/or chemically modified styrene butadiene rubber, polyethylene oxides, and polyacrylonitrile, and copolymers of polyethylene oxides and polyacrylonitrile, polyethylene and polypropylene, polyethylene oxides and polyacrylamide, poly vinyl alcohols and polyacrylamide, polystyrenebutadiene rubber and poly(acrylonitrile-co-acrylamide), and poly(acrylonitrile-co-acrylamide), and physically- and/or chemically-modified versions of any of the polymers or co-polymers listed above or mixtures or co-polymers of any of the polymers or co-polymers listed above.

18. An electrode active mix for coating onto a current collector for an electrochemical cell, the electrode active mix comprising:
an electrode active material;
a conductive additive material;
a water-soluble polymeric binder; and
water;
wherein the electrode active mix has a viscosity in the range of 2,000 to 100,000 centipoise (2 Pa·s to 100 Pa·s) and being devoid of a thickening agent.

19. The electrode active mix of claim 18, wherein the electrode active mix is comprised of at least 70 percent by weight electrode active material, approximately 1-10 percent by weight conductive additive material, and approximately 1-10 percent by weight a combination of the polymeric binder and water.

20. The electrode active mix of claim 18, wherein the electrode mix comprises at least 70 percent by weight electrode active material when the electrode mix has been dried.
